(19) United States
(12) Patent Application Publication
(10) Pub. No.: US 2025/0223994 A1
(43) Pub. Date: Jul. 10, 2025

(54) REINFORCED POLYMER NUTS FOR SOCKET LOADING

(71) Applicants: Eric W. Buddrius, Hillsboro, OR (US); Garrett Frans Pauwels, Beaverton, OR (US); Daniel J. Neumann, Tualatin, OR (US); Shelby Ferguson, El Dorado Hills, CA (US); Emery E. Frey, Portland, OR (US); Dawson Leander Willems, Newberg, OR (US); Guebum Han, Portland, OR (US); Andrew Robert Larson, Hillsboro, OR (US); Richard Canham, West Richland, WA (US); Ralph V. Miele, Hillsboro, OR (US)

(72) Inventors: Eric W. Buddrius, Hillsboro, OR (US); Garrett Frans Pauwels, Beaverton, OR (US); Daniel J. Neumann, Tualatin, OR (US); Shelby Ferguson, El Dorado Hills, CA (US); Emery E. Frey, Portland, OR (US); Dawson Leander Willems, Newberg, OR (US); Guebum Han, Portland, OR (US); Andrew Robert Larson, Hillsboro, OR (US); Richard Canham, West Richland, WA (US); Ralph V. Miele, Hillsboro, OR (US)

(21) Appl. No.: 19/094,586

(22) Filed: Mar. 28, 2025

(51) Int. Cl. F16B 37/00

(52) U.S. Cl. CPC F16B 37/00

(57) ABSTRACT

Reinforced nuts comprise a polymer nut body and a metal casing fitted to an outer surface of the nut body. In some embodiments, the metal casing can cover the top of the polymer nut body and comprise a drive opening so that the casing carries a portion of an applied torque when the nut is being tightened. In other embodiments, the metal case can cover a portion of the bottom surface of the polymer nut body. Reinforced nuts can also comprise a cylindrical metal sleeve that is embedded in a polymer nut body. The metal sleeve can be solid, porous, comprise holes, or be a mesh. The reinforced nuts have an increased strength relative to nuts that are not reinforced and can thus handle a greater load when they nuts are being tightened.

### BACKGROUND

A processor can be secured to a socket by inserting the processor into the socket and providing a mechanical load to the processor. In some embodiments, the mechanical load can be provided by securing a load assembly to a socket by tightening the nuts of the load assembly to the fasteners of the socket.

### BRIEF DESCRIPTION OF THE DRAWINGS

FIG. 1 is an exploded perspective view of an example socket assembly.

FIGS. 2A-2B illustrate perspective and cross-sectional views of a first example reinforced nut.

FIGS. 3A-3B illustrate perspective and cross-sectional views of a second example reinforced nut.

FIGS. 4A-4B illustrate perspective and cross-sectional views of a third example reinforced nut.

FIGS. 5A-5B illustrate perspective and cross-sectional views of a fourth example reinforced nut.

FIGS. 6A-6B illustrate perspective and top views of an example casing with splines.

FIGS. 7A-7B illustrate perspective and top views of an example metal casing with tabs.

FIGS. 8A-8C illustrate a perspective transparent view, a top view, and a cross-sectional view, respectively, of a fifth example reinforced nut.

FIGS. 9A-9B illustrate top views of a load assembly comprising reinforced nuts.

FIG. 10 is a first method of assembling a socket assembly.

FIG. 11 is a second method of assembling a socket assembly.

FIG. 12 is a second method of assembling a socket assembly.

FIG. 13 is a block diagram of a second example computing system in which technologies described herein may be implemented.

FIG. 14 is a block diagram of an example processor unit to execute computer-executable instructions as part of implementing technologies described herein.

### DETAILED DESCRIPTION

To secure a processor or any other integrated circuit component to a socket, a mechanical load can be applied to the integrated circuit component after it has been inserted into the socket. In some embodiments, the mechanical load takes the form of a load assembly attached to the socket by fastening nuts that are part of the load assembly to fasteners that are part of the socket.

In some existing socket loading solutions where the load is applied by securing nuts of the load assembly to fasteners of the socket, the nuts can be made from a high performance thermoplastic, such as polyether ether ketone (PEEK). Nuts made from PEEK (PEEK nuts) can satisfy high installation cycle count requirements while leaving little or no residue. Despite these advantages, PEEK nuts are weaker than common metal-based nuts. As the force that socket loading mechanisms need to support continues to increase with increasing integrated circuit component package size and pin count, this force is approaching the limit that PEEK nuts can handle. If too much torque is applied, PEEK nuts can crack in half. Cracked nuts can result in a socket loading solution that does not reliably secure an integrated circuit component to a socket and can result in one or more pins of an integrated circuit component losing electrical connectivity to the socket. Increasing the size of the nuts can increase nut strength, but this comes at the cost of an increased footprint, which can reduce the available footprint for other load assembly components, such as heat sinks. Increasing nut size while preserving load assembly real estate for other components may yield in stronger nuts but they still may not be able to handle the load required by modern and future socket assembly designs.

Described herein are reinforced nuts for use in socket loading that comprise a metal casing or sleeve to increase the strength of the nuts. As a metal casing or sleeve has a significantly greater stiffness and strength than the polymer material that typically forms the body of these nuts, it can carry a portion of the forces that would otherwise be applied only to the polymer. This allows for a greater torque to be applied to a nut before it begins to crack. A metal casing can be fitted to the outer surface of a nut to induce a compressive force on the polymer nut. The casing can extend along the full height or just a portion of the height of a nut. The casing can additionally cover the base of a nut. A metal casing can cover a top surface of a nut as well and can have a drive opening that matches the shape of the drive recess of the nut, allowing the casing to carry a portion of the mechanical load applied to the nut when it is being tightened. The interior surface of the casing can comprise splines or tabs that engage with the outer surface of the polymer nut body to allow for a stronger physical engagement between the casing and the body. In some embodiments, instead of a casing fitted to the outside of the polymer nut body, a reinforced nut can comprise a metal sleeve embedded in the nut body. The sleeve can be continuous, porous, have holes in it, be a mesh, or take other suitable configurations.

Reinforced nuts with a metal casing or an embedded sleeve have the advantages of increased strength and being less susceptible to cracking, while still providing the high installation cycle count and low-residue performance of polymer nuts. Reinforced nuts can also enable the use of thinner nuts. The increased strength of the metal casing or sleeve allows for reinforced nuts to be used that are thinner than existing PEEK nuts while still providing for increased strength over the PEEK nuts.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner.

As used herein, the term “connected” may indicate elements are in direct physical or electrical contact with each other and “coupled” may indicate elements co-operate or interact with each other, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, a metal casing having an opening with a shape that substantially matches the shape of a drive recess of a nut body includes metal casings with shapes that are slightly different that the drive recess shape but that still bears a portion of the load when the reinforced nut is tightened, and casings that have a bottom opening that substantially aligns with the opening of a nut body include casings that have a bottom opening that are offset by a small amount from the nut body opening but that still allow for a socket fastener to extend through the casing bottom opening into the nut body opening.

Reference is now made to the drawings, which are not necessarily drawn to scale, wherein similar or same numbers may be used to designate same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

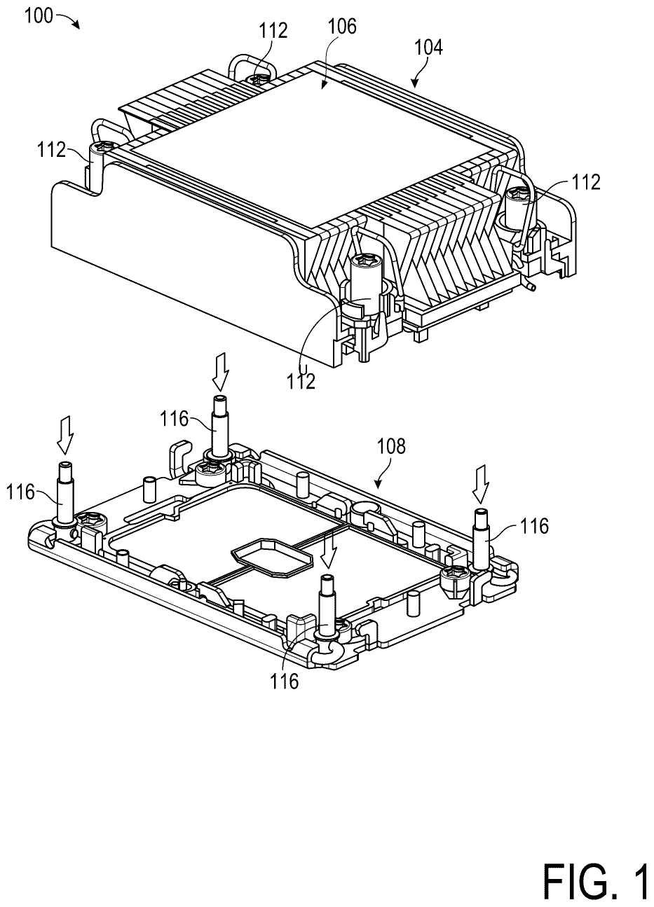

FIG. 1 is an exploded perspective view of an example socket assembly. The socket assembly 100 comprises a load assembly 104 and a socket 108. The load assembly 104 comprises a heat sink 106 and nuts 112. The socket 108, which is illustrated as unpopulated, comprises fasteners 116 that are threaded. To apply a loading force to the socket to ensure electrical connections between the pins of an integrated circuit component inserted in the socket and the socket pins (or pads), the load assembly 104 is first placed on the socket 108, with the nuts 112 being placed over the fasteners 116. The nuts 112 are then tightened to secure the nuts 112 to the fasteners 116, resulting in a downward force being applied to the integrated circuit component.

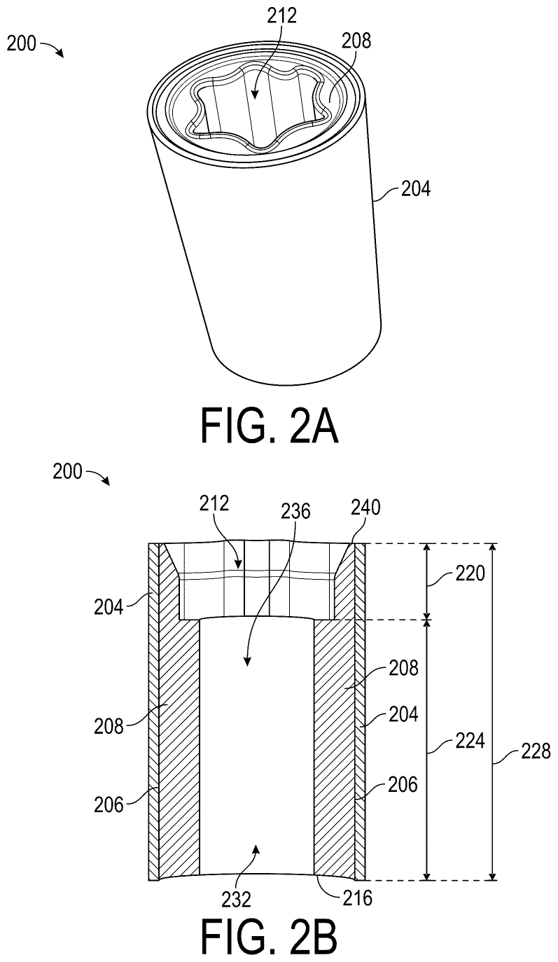

FIGS. 2A-2B illustrate perspective and cross-sectional views of a first example reinforced nut. Reinforced nut 200 comprises a casing 204 fitted to an outer surface 206 of a body 208 to increase its strength and resilience to cracking. In any of the embodiments described herein, a casing or sleeve providing mechanical reinforcement to a nut comprises a suitable metal, such as stainless steel, steel, aluminum, or copper. Further, in any of the embodiments described herein, the body of the nut comprises a polymer, such as a plastic or thermoplastic (e.g., polyether ether ketone (PEEK)). In some embodiments, the polymer is PEEK thermoplastic reinforced with glass and carbon.

The body 208 comprises an opening 236 that extends from a bottom surface 216 to a top surface 240 of the body 208. A first portion of the opening 236 (first opening portion 232) extends towards the top surface 240 from the bottom surface 216. The first opening portion 232 is threaded (threads not shown) for engagement with a counterpart threaded fastener. A second portion of the opening 236 comprises a drive recess 212 for receiving a driver to secure or remove the reinforced nut 200 to or from a fastener. The drive recess 212 illustrated in FIGS. 2A-2B is a six-pointed star-shaped recess (which, in some embodiments, can be a Torx® drive). Any of the reinforced nuts disclosed herein can have a drive recess suitable for receiving any type of a driver, such as slotted drive recess for receiving a flathead screwdriver or a cross-shaped recess for receiving a Phillips screwdriver. The reinforced nut 200 has a height 228, with the first opening portion 232 extending a height 224 and the drive recess 212 extending a height 220.

In FIGS. 2A-2B, the casing 204 extends the height 224 of the reinforced nut 200. In other embodiments, the casing 204 extends to a portion of the height 228. Casings that extend only a portion of the height 228 can extend from the bottom surface 216 towards the top surface 240, from the top surface 240 towards the bottom surface, or do not coincide with either the bottom surface 216 or the top surface 240 (such as a casing that wraps around the middle of the reinforced nut 200, like a belt).

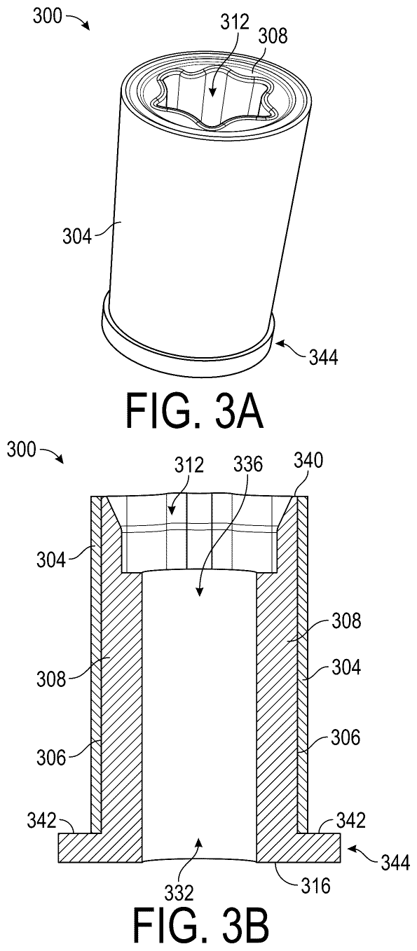

FIGS. 3A-3B illustrate perspective and cross-sectional views of a second example reinforced nut. Reinforced nut 300 is similar to reinforced nut 200 in that a casing 304 is fitted to an outer surface 306 of a body 308, but differs in at least that the casing 304 does not extend the full height of the reinforced nut 300. The reinforced nut 300 comprises an opening 336 that extends from a bottom surface 316 to a top surface 340 of the body 308. A first portion of the opening 336 (first opening portion 332) extends towards the top surface 340 from the bottom surface 316. The first opening portion 332 is threaded. A second portion of the opening 336 comprises a drive recess 312 for receiving a driver to secure or remove the reinforced nut 300 to or from a fastener. The casing 304 extends from the top surface 340 to a top surface 342 of a pedestal or base portion (pedestal 344) of the body 308. The pedestal 344 has a width that is greater than the width of the remainder of the body 308 to which the casing 304 is fitted.

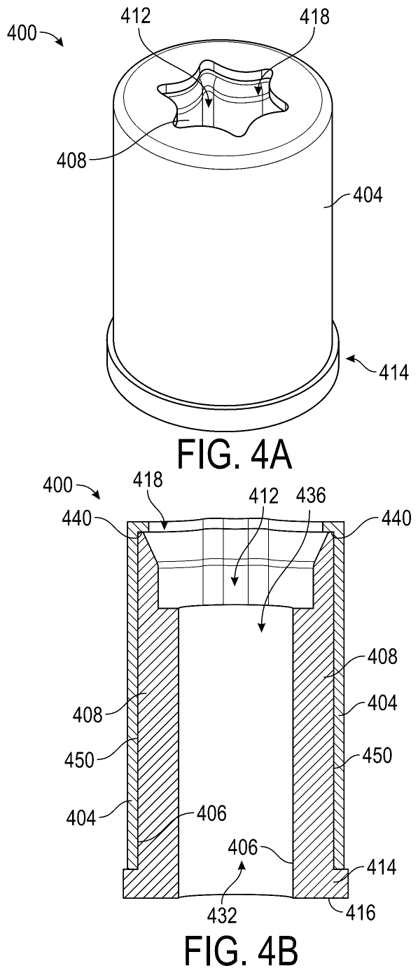

FIGS. 4A-4B illustrate perspective and cross-sectional views of a third example reinforced nut. The reinforced nut 400 is similar to reinforced nut 200 in that a casing 404 is fitted to an outer surface 406 of a body 408, but differs in at least that the casing 404 covers a top surface 440 of the body 408. The reinforced nut 400 comprises an opening 436 that extends from a bottom surface 416 to the top surface 440 of the body 408. A first portion of the opening 436 (first opening portion 432) extends towards the top surface 440 from the bottom surface 416. The first opening portion 432 is threaded. A second portion of the opening 436 comprises a drive recess 412 for receiving a driver to secure or remove the reinforced nut 400 to or from a fastener. The casing 404 further comprises a drive opening 418 that has a shape that substantially matches the shape of the drive recess 412. This allows the casing 404 to bear a portion of the torque applied to the reinforced nut 400 when the nut is tightened. The drive opening 418 may reduce the possibility of the driver stripping out when the reinforced nut 400 is tightened.

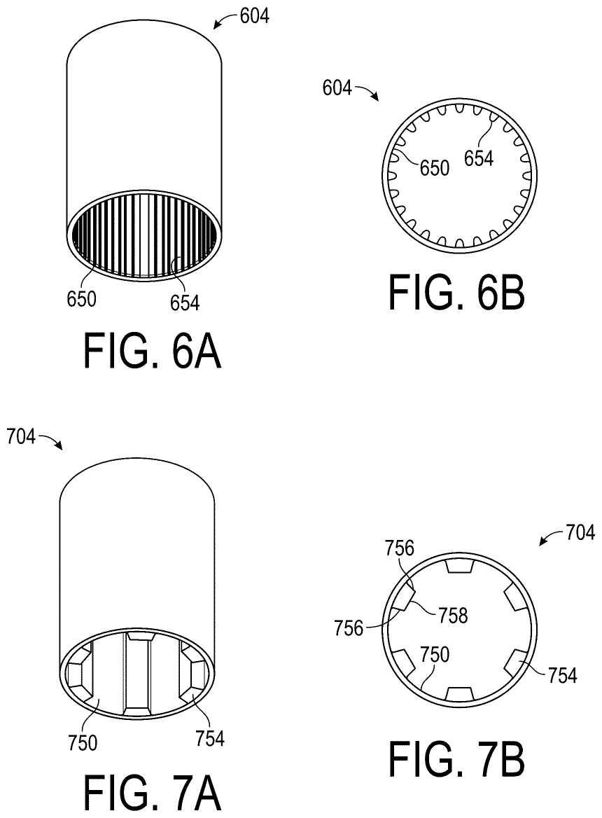

In some embodiments, the casing 404 may possess splines or tabs on its interior surface 450 (where the casing 404 engages with the body 408) to aid in transferring torque from the casing 404 to the body 408. These features may further aid in preventing separation between the body 408 and the casing 404 when torque is applied to the nut. Example splines and tabs are illustrated in FIGS. 6A-6B and 7A-7B.

The casing 404 covers the top surface 440 of the body 408 and extends towards the bottom surface 416 but does not extend all of the way to the bottom surface 416. The casing 404 abuts a base portion 414 of the body. The base portion 414 is wider than the remainder of the casing 404 to which the casing 404 is fitted. In other embodiments of a reinforced nut with a metal casing that covers the top surface of the polymer nut body, the metal casing extends the full height of the polymer body.

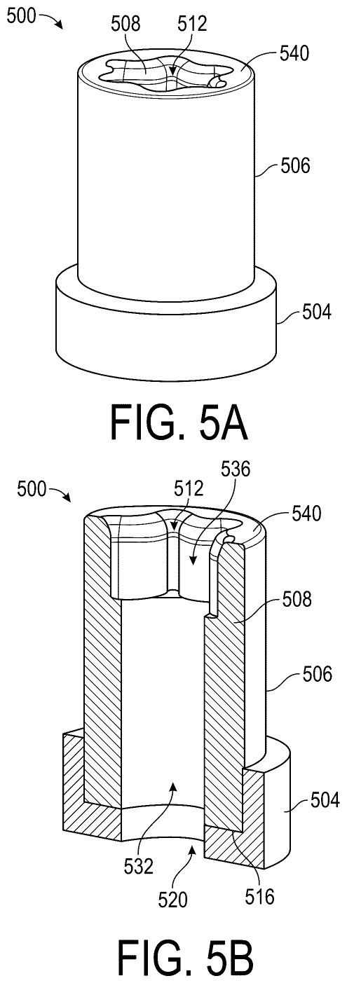

FIGS. 5A-5B illustrate perspective and perspective cross-sectional views of a fourth example reinforced nut. The reinforced nut 500 comprises a body 508 and a casing 504. The body 508 comprises an opening 536 that extends from a bottom surface 516 to the top surface 540 of the body 508. A first portion of the opening 536 (first opening portion 532) extends towards the top surface 540 from the bottom surface 516. The first opening portion 532 is threaded. A second portion of the opening 536 comprises a drive recess 512 for receiving a driver to secure or remove the reinforced nut 500 to or from a fastener. The casing 504 is fitted to a bottom portion of an outer surface 506 of the body 508. The casing 504 further covers the bottom surface 516 of the body 508 and has an opening 520 that is substantially aligned with the opening 536 of the body 508. By covering the bottom surface 516 of the body 508, the casing 504 can provide a high durability load-bearing surface for the reinforced nut 500. The casing 504 can extend the height of the reinforced nut 500 or, as illustrated in FIGS. 5A-5B, may extend along only a bottom portion of the height of the reinforced nut, where the stress on the reinforced nut 500 is greatest when the reinforced nut 500 is being tightened. In some embodiments, the casing 504 covers only a portion of the bottom surface 516 of the body 508.

FIGS. 6A-6B illustrate perspective and top views of an example casing with splines. The casing 604 comprises splines 654 on an interior surface 650 of the casing 604. As mentioned above, the splines 654 can increase the degree of physical engagement between the casing and a nut body by creating a high-friction torque-transmitting connection between the casing and a nut body. Casings with splines can be of particular use in reinforced nuts that have a drive opening, such as reinforced nut 400, as the splines can aid in distributing the torque carried by the casing across the outer surface of the polymer nut body. The splines 654 are illustrated as parallel splits but can be another type of spline in other embodiments, such as helical, knurled, serrated, or involute splines.

FIGS. 7A-7B illustrate perspective and top views of an example metal casing with tabs. The casing 704 comprises tabs 754 on an interior surface 750 of the casing 704. Like the splines 654 in the casing 604, the tabs 754 can increase the degree of physical engagement between the casing 704 and a polymer nut body. The tabs 754 engage with counterpart tabs located on an outer surface of a polymer nut body. The tabs 754 are illustrated as having sidewalls 756 and edges 758, but the tabs can have any other suitable configuration in other embodiments.

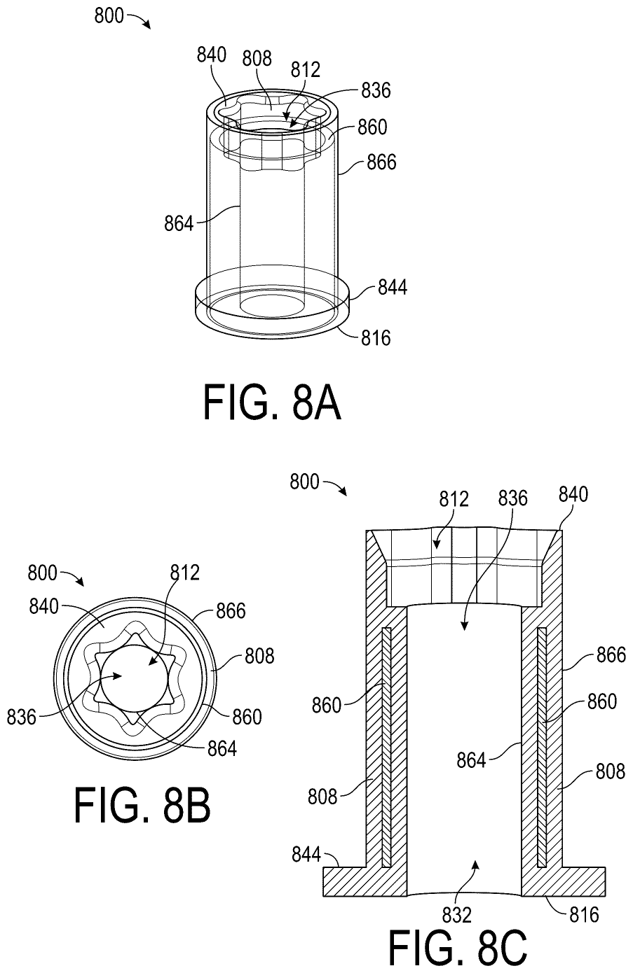

FIGS. 8A-8C illustrate a perspective transparent view, a top view, and a cross-sectional view, respectively, of a fifth example reinforced nut. The reinforced nut 800 comprises a reinforcement structure 860 embedded within a body 808. The body 808 comprises an opening 836 that extends from a bottom surface 816 to the top surface 840 of the body 808. A first portion of the opening 836 (first opening portion 832) extends towards the top surface 840 from the bottom surface 816. The first opening portion 832 is threaded. A second portion of the opening 836 comprises a drive recess 812 for receiving a driver to secure the reinforced nut 800 to or remove the nut from a fastener. The body 808 comprises a pedestal 844.

The reinforcement structure 860, which is illustrated as a sleeve in FIGS. 8A-8C, is located between an inner surface 864 and an outer surface 866 of the body 808. The reinforcement structure 860 has a cylindrical shape but can have any other suitable shape in other embodiments. The reinforcement structure 860 can be solid (not have any openings in it), porous, have holes in it, be a mesh, or have any other suitable configuration that allows the sleeve to impart mechanical strength to the body 808. In some embodiments, the reinforcement structure 860 can have a configuration that is advantageous for manufacturing of the reinforced nut and reduce potential manufacturing risks, such as mold flashing. In any of the reinforced nuts described herein comprising a metal casing fitted to the outside surface of a polymer nut, the casing can also have various configurations, such as being solid, porous, having holes in it, or being a mesh.

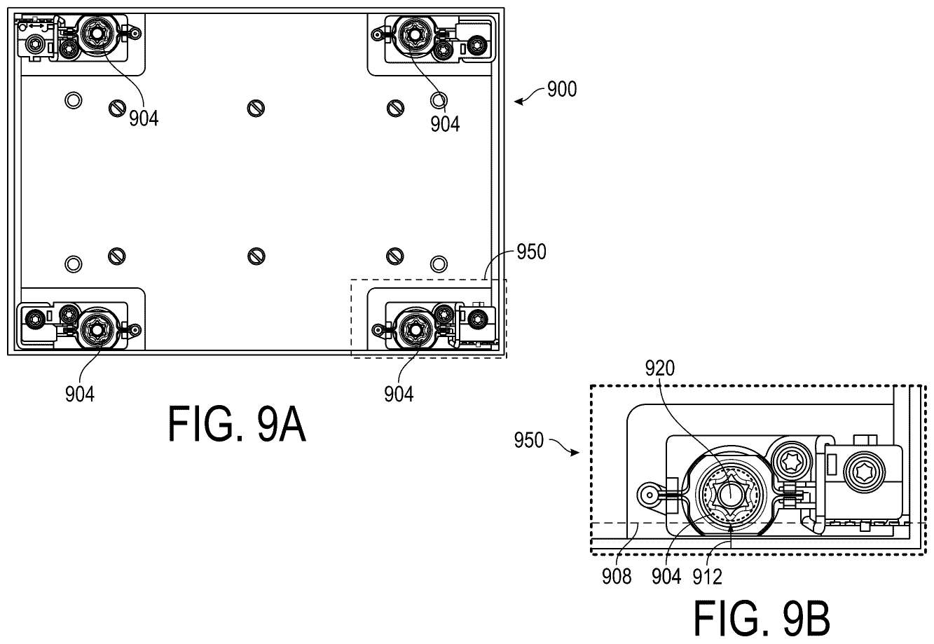

FIGS. 9A-9B illustrate top views of a load assembly comprising reinforced nuts. FIG. 9A illustrates a top view of a load assembly 900 comprising reinforced nuts 904 attached to a socket. FIG. 9B illustrates a detailed view of the region 950 in FIG. 9A and shows one of the reinforced nuts 904 secured to a fastener 920 of the socket. Dashed line 908 illustrates a keep-out-zone defined by the size of the reinforced nut 904. The circular dashed line indicates the outer circumference of the reinforced nut 904. Line 912 indicates the distance of the keep-out-zone from an edge of the load assembly 900. As the inclusion of a metal casing or sleeve can increase the strength of a socket loading nut enough such that the diameter of the width can be reduced while still providing the necessary level of strength, keep-out-zones associated with reinforced nuts can be smaller than that for a socket loading polymer nut that does not have a metal casing or metal sleeve reinforcement.

In any of the reinforced nuts described herein, the reinforced nuts may be designed such that threads of the nut begin to strip before any cracking would occur.

The reinforced nuts disclosed herein can be formed using various methods. In some embodiments, the casing can be press-fit onto a polymer nut body to create a secure friction-based connection between the casing and the polymer nut body. In a variation of these embodiments, the casing can be heated before being fit onto the nut body. The expansion of the casing when it is heated allows for a simpler assembly (i.e., requiring less force to fit the casing onto the nut body). As the casing cools, it contracts around the nut, providing a tight fit and applying a compressive stress to the nut body, which pre-stresses the nut body. Heat-expanded press-fit reinforced nuts can potentially be stronger than press-fit reinforced nuts formed without heat expansion. A third approach of forming reinforced nuts comprises over-molding metal casings or sleeves. In these embodiments, a metal casing or sleeve is molded onto a surface of a polymer nut body during the molding process. The casing or sleeve may be molded on the exterior surface of the nut body or embedded in the nut body. In some over-molding processes, an inner nut body may first be formed with a sleeve, then formed over the inner nut body. Then, an outer nut body can be molded over the sleeve.

Finite-element analysis of a press-fit reinforced socket loading PEEK nut indicates that the reinforced nut can reduce the Von Mises stress at the inner surface of the PEEK nut by about 70% compared to nut designs that are not reinforced as described herein. Additionally, the casing shifted the hoop stress component from tensile to compressive. These findings suggest that the reinforced nuts disclosed herein may be able to improve the load-bearing capacity of PEEK nut and prevent tensile-driven crack failure, which is crucial for consistent and reliable socket assembly performance.

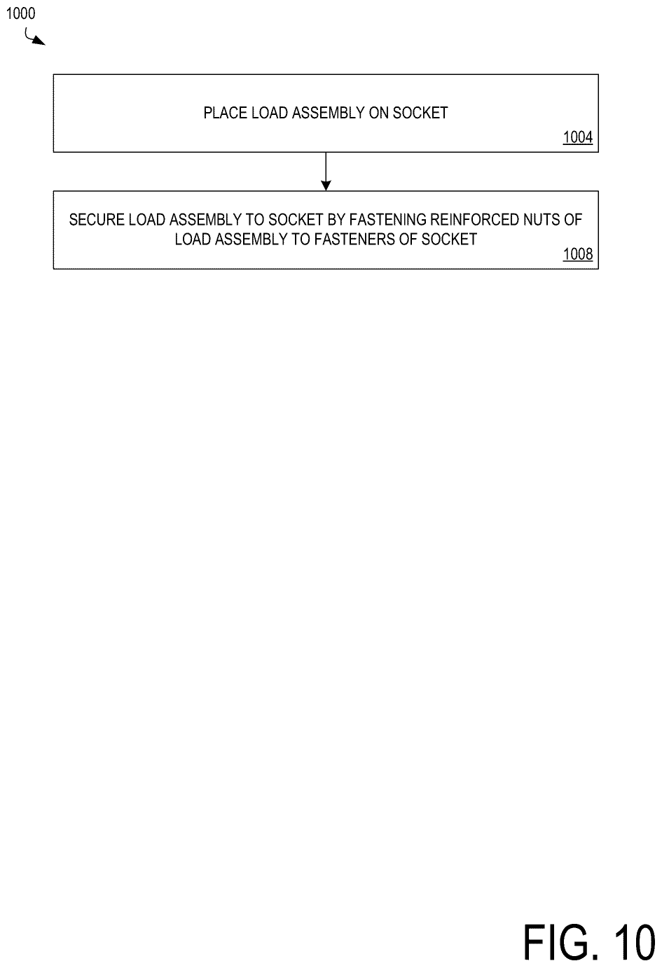

FIG. 10 is an example method of loading a socket. The method 1000 can be performed by a computing system original equipment manufacturer. At stage 1004, a load assembly is placed on a socket, wherein the socket comprises a plurality of fasteners and the load assembly comprises a plurality of reinforced nuts. At stage 1008, the load assembly is secured to the socket by fastening the plurality of reinforced nuts.

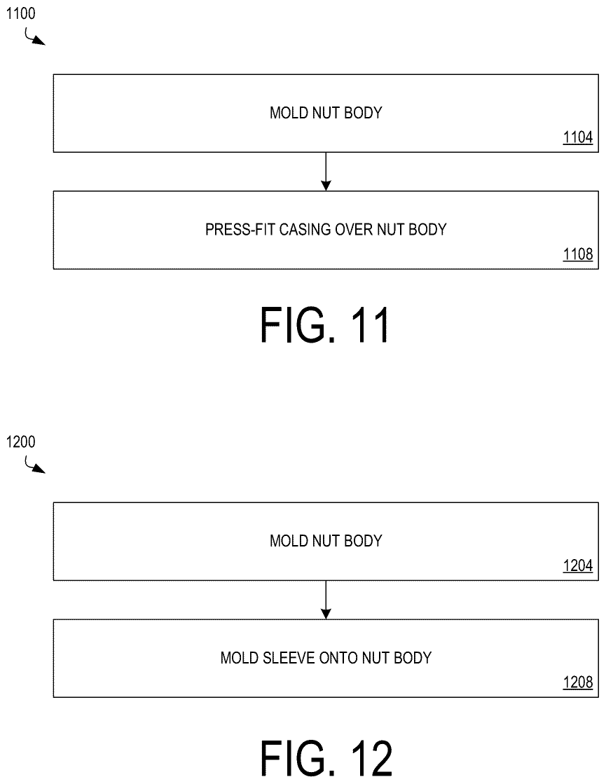

FIG. 11 is a first example method of forming reinforced nuts. The method 1100 can be performed by a nut manufacturer. At stage 1104, a nut body is molded out of a polymer, wherein the nut body comprises an outer surface, a bottom surface, a top surface, and an opening, wherein the opening extends from the bottom surface to the top surface, a threaded first portion of the opening extends from the bottom surface towards the top surface, a second portion of the opening extends from the top surface comprises a drive recess, and the nut body comprises a polymer. At stage 1108, a casing is press-fit over the nut body, the casing comprising a metal.

FIG. 12 is a second example method of forming reinforced nuts. The method 1200 can be performed by a nut manufacturer. At stage 1204, a nut body is molded out of a polymer, wherein the nut body comprises an outer surface, a bottom surface, a top surface, and an opening, wherein the opening extends from the bottom surface to the top surface, a threaded first portion of the opening extending from the bottom surface towards the top surface, a second portion of the opening extends from the top surface comprises a drive recess, and the nut body comprises a plastic. At stage 1208, a sleeve is molded onto the nut body, the sleeve comprising a metal.

As used herein, the term “integrated circuit component” refers to a packaged or unpacked integrated circuit product. A packaged integrated circuit component comprises one or more integrated circuit dies mounted on a package substrate with the integrated circuit dies and package substrate encapsulated in a casing material, such as a metal, plastic, glass, or ceramic. In one example, a packaged integrated circuit component contains one or more processor units mounted on a substrate with an exterior surface of the substrate comprising a solder ball grid array (BGA). In one example of an unpackaged integrated circuit component, a single monolithic integrated circuit die comprises solder bumps attached to contacts on the die. The solder bumps allow the die to be directly attached to a printed circuit board. An integrated circuit component can comprise one or more of any computing system component described or referenced herein or any other computing system component, such as a processor unit (e.g., system-on-a-chip (SoC), processor core, graphics processor unit (GPU), accelerator, chipset processor), I/O controller, memory, or network interface controller.

Certain terminology may also be used herein for reference only and thus are not intended to be limiting. For example, terms such as “upper,” “lower,” “above,” “below,” “bottom,” and “top” refer to directions in the Figures to which reference is made. Terms such as “front,” “back,” “rear,” and “side” describe the orientation and/or location of layers, components, portions of components, etc., within a consistent but arbitrary frame of reference, which is made clear by reference to the text and the associated Figures describing the layers, component, portions of components, etc. under discussion. Such terminology may include the words specifically mentioned above, derivatives thereof, and words of similar import.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the software or firmware instructions are not actively being executed by the system, device, platform, or resource.

The technologies described herein can or implemented in any of a variety of computing systems, including desktop computers, servers, workstations, stationary gaming consoles, rack-level computing solutions (e.g., blade, tray, or sled computing systems)), and embedded computing systems (e.g., computing systems that are part of a vehicle, smart home appliance, consumer electronics product or equipment, manufacturing equipment).

As used herein, the term “computing system” includes computing devices and includes systems comprising multiple discrete physical components. In some embodiments, the computing systems are located in a data center, such as an enterprise data center (e.g., a data center owned and operated by a company and typically located on company premises), managed services data center (e.g., a data center managed by a third party on behalf of a company), a colocated data center (e.g., a data center in which data center infrastructure is provided by the data center host and a company provides and manages their own data center components (servers, etc.)), cloud data center (e.g., a data center operated by a cloud services provider that hosts companies' applications and data), or an edge data center (e.g., a data center typically having a smaller footprint than other data center types, located close to the geographic area that it serves).

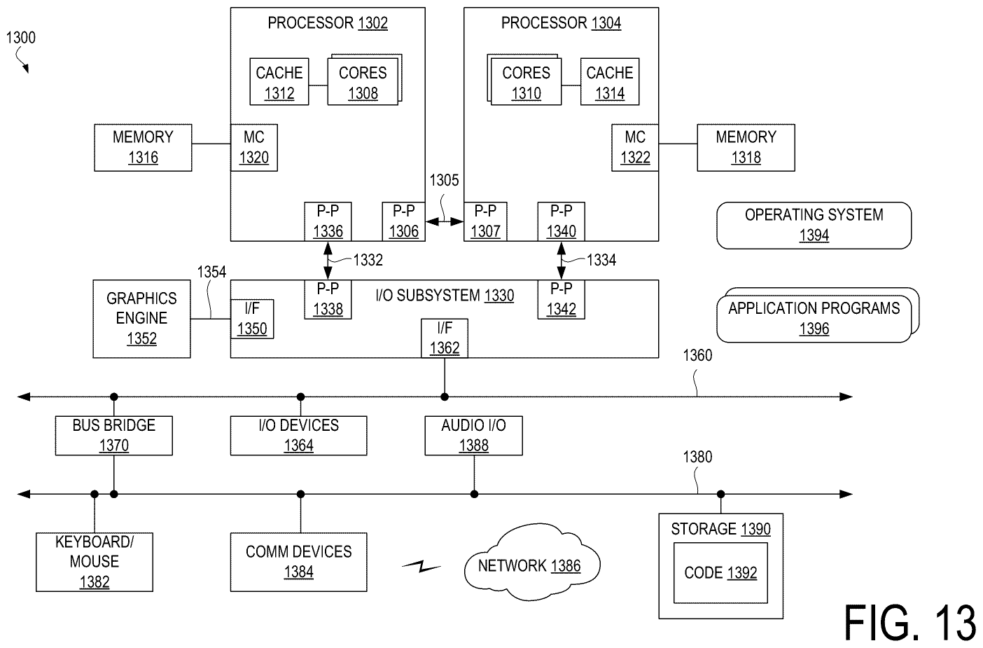

FIG. 13 is a block diagram of a second example computing system in which technologies described herein may be implemented. Generally, components shown in FIG. 13 can communicate with other shown components, although not all connections are shown, for ease of illustration. The computing system 1300 is a multiprocessor system comprising first processor unit 1302 and second processor unit 1304 comprising point-to-point (P-P) interconnects. A point-to-point (P-P) interface 1306 of the first processor unit 1302 is coupled to a point-to-point interface 1307 of the second processor unit 1304 via a point-to-point interconnection 1305. It is to be understood that any or all of the point-to-point interconnects illustrated in FIG. 13 can be alternatively implemented as a multi-drop bus, and that any or all buses illustrated in FIG. 13 could be replaced by point-to-point interconnects.

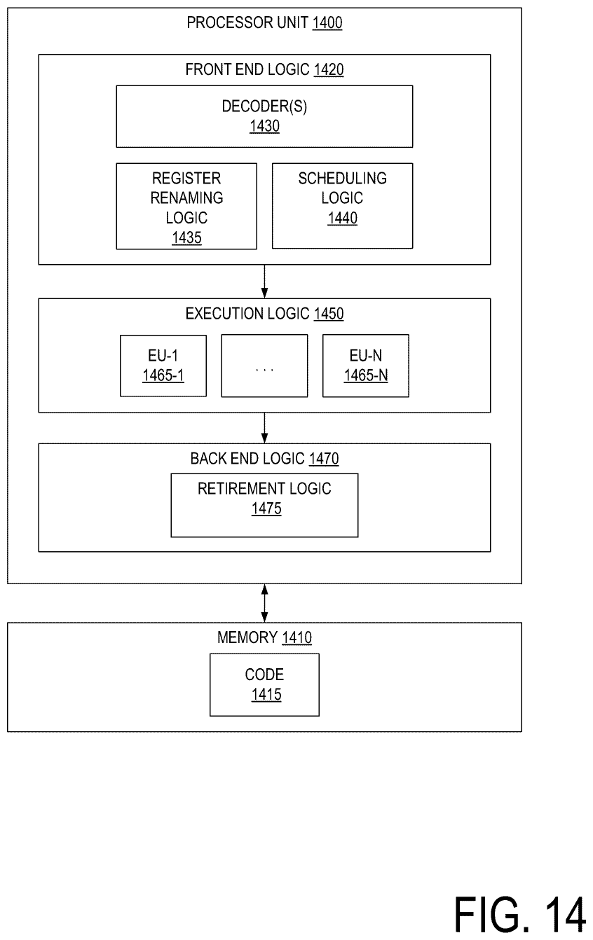

The first processor unit 1302 and the second processor unit 1304 comprise multiple processor cores. The first processor unit 1302 comprises processor cores 1308 and the second processor unit 1304 comprises processor cores 1310. Processor cores 1308 and 1310 can execute computer-executable instructions in a manner similar to that discussed below in connection with FIG. 14, or other manners.

The first processor unit 1302 and the second processor unit 1304 further comprise cache memories 1312 and 1314, respectively. The cache memories 1312 and 1314 can store data (e.g., instructions) utilized by one or more components of the first processor unit 1302 and the second processor unit 1304, such as the processor cores 1308 and 1310. The cache memories 1312 and 1314 can be part of a memory hierarchy for the computing system 1300. For example, the cache memories 1312 can locally store data that is also stored in a first memory 1316 to allow for faster access to the data by the first processor unit 1302. In some embodiments, the cache memories 1312 and 1314 can comprise multiple cache memories that are a part of a memory hierarchy. The cache memories in the memory hierarchy can be at different cache memory levels, such as level 1 (L1), level 2 (L2), level 3 (L3), level 4 (L4), or other cache memory levels. In some embodiments, one or more levels of cache memory (e.g., L2, L3, L4) can be shared among multiple cores in a processor unit or among multiple processor units in an integrated circuit component. In some embodiments, the last level of cache memory in an integrated circuit component can be referred to as a last-level cache (LLC). One or more of the higher levels of cache levels (the smaller and faster cache memories) in the memory hierarchy can be located on the same integrated circuit die as a processor core and one or more of the lower cache levels (the larger and slower caches) can be located on one or more integrated circuit dies that are physically separate from the processor core integrated circuit dies.

Although the computing system 1300 is shown with two processor units, the computing system 1300 can comprise any number of processor units. Further, a processor unit can comprise any number of processor cores. A processor unit can take various forms such as a central processing unit (CPU), graphics processing unit (GPU), general-purpose GPU (GPGPU), accelerated processing unit (APU), field-programmable gate array (FPGA), neural network processing unit (NPU), data processor unit (DPU), accelerator (e.g., graphics accelerator, digital signal processor (DSP), compression accelerator, artificial intelligence (AI) accelerator), controller, or other type of processing unit. As such, the processor unit can be referred to as an XPU (or xPU). Further, a processor unit can comprise one or more of these various types of processing units. In some embodiments, the computing system comprises one processor unit with multiple cores, and in other embodiments, the computing system comprises a single processor unit with a single core. As used herein, the terms “processor unit” and “processing unit” can refer to any processor, processor core, component, module, engine, circuitry, or any other processing element described or referenced herein.

In some embodiments, the computing system 1300 can comprise one or more processor units that are heterogeneous or asymmetric to another processor unit in the computing system. There can be a variety of differences between the processing units in a system in terms of a spectrum of metrics of merit including architectural, microarchitectural, thermal, power consumption characteristics, and the like. These differences can effectively manifest themselves as asymmetry and heterogeneity among the processor units in a system.

The first processor unit 1302 and the second processor unit 1304 can be located in a single integrated circuit component (such as a multi-chip package (MCP) or multi-chip module (MCM)) or they can be located in separate integrated circuit components. An integrated circuit component comprising one or more processor units can comprise additional components, such as embedded DRAM, stacked high bandwidth memory (HBM), shared cache memories (e.g., L3, L4, LLC), input/output (I/O) controllers, or memory controllers. Any of the additional components can be located on the same integrated circuit die as a processor unit, or on one or more integrated circuit dies separate from any integrated circuit die containing a processor unit. In some embodiments, these separate integrated circuit dies can be referred to as “chiplets”. In some embodiments, where there is heterogeneity or asymmetry among processor units in a computing system, the heterogeneity or asymmetric can be among processor units located in the same integrated circuit component. In embodiments where an integrated circuit component comprises multiple integrated circuit dies, interconnections between dies can be provided by a package substrate, one or more silicon interposers, one or more silicon bridges embedded in a package substrate (such as Intel® embedded multi-die interconnect bridges (EMIBs)), or combinations thereof.

The first processor unit 1302 further comprises first memory controller logic (first MC 1320) and the second processor unit 1304 further comprises second memory controller logic (second MC 1322). As shown in FIG. 13, a first memory 1316 coupled to the first processor unit 1302 is controlled by the first MC 1320 and a second memory 1318 coupled to the second processor unit 1304 is controlled by the second MC 1322. The first memory 1316 and the second memory 1318 can comprise various types of volatile memory (e.g., dynamic random-access memory (DRAM), static random-access memory (SRAM)) and/or non-volatile memory (e.g., flash memory, chalcogenide-based phase-change non-volatile memories). The first memory 1316 and the second memory 1318 can comprise one or more layers of a memory hierarchy of the computing system. While first MC 1320 and second MC 1322 are illustrated as being integrated into the first processor unit 1302 and the second processor unit 1304, in alternative embodiments, memory controller logic can be external to a processor unit.

The first processor unit 1302 and the second processor unit 1304 are coupled to an Input/Output subsystem 1330 (I/O subsystem) via point-to-point interconnections 1332 and 1334. The point-to-point interconnection 1332 connects a point-to-point interface 1336 of the first processor unit 1302 with a point-to-point interface 1338 of the Input/Output subsystem 1330, and the point-to-point interconnection 1334 connects a point-to-point interface 1340 of the second processor unit 1304 with a point-to-point interface 1342 of the Input/Output subsystem 1330. Input/Output subsystem 1330 further includes an interface 1350 to couple the Input/Output subsystem 1330 to a graphics engine 1352. The Input/Output subsystem 1330 and the graphics engine 1352 are coupled via a bus 1354.

The Input/Output subsystem 1330 is further coupled to a first bus 1360 via an interface 1362. The first bus 1360 can be a Peripheral Component Interconnect Express (PCIe) bus or any other type of bus. Various I/O devices 1364 can be coupled to the first bus 1360. A bus bridge 1370 can couple the first bus 1360 to a second bus 1380. In some embodiments, the second bus 1380 can be a low pin count (LPC) bus. Various devices can be coupled to the second bus 1380 including, for example, a keyboard/mouse 1382, audio I/O devices 1388, and a storage device 1390, such as a hard disk drive, solid-state drive, or another storage device for storing computer-executable instructions (or code 1392) or data. The code 1392 can comprise computer-executable instructions for performing methods described herein. Additional components that can be coupled to the second bus 1380 include one or more communication devices 1384, which can provide for communication between the computing system 1300 and one or more wired or wireless networks 1386 (e.g. Wi-Fi, cellular, or satellite networks) via one or more wired or wireless communication links (e.g., wire, cable, Ethernet connection, radio-frequency (RF) channel, infrared channel, Wi-Fi channel) using one or more communication standards (e.g., IEEE 502.11 standard and its supplements).

In embodiments where the one or more communication devices 1384 support wireless communication, the one or more communication devices 1384 can comprise wireless communication components coupled to one or more antennas to support communication between the computing system 1300 and external devices. The wireless communication components can support various wireless communication protocols and technologies such as Near Field Communication (NFC), IEEE 1002.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM), and 5G broadband cellular technologies. In addition, the wireless modems can support communication with one or more cellular networks for data and voice communications within a single cellular network, between cellular networks, or between the computing system and a public switched telephone network (PSTN).

The computing system 1300 can comprise removable memory such as flash memory cards (e.g., SD (Secure Digital) cards), memory sticks, Subscriber Identity Module (SIM) cards). The memory in computing system 1300 (including cache memories 1312 and 1314, first memory 1316, second memory 1318, and storage device 1390) can store data and/or computer-executable instructions for executing an operating system 1394 and application programs 1396. The computing system 1300 can also have access to external memory or storage (not shown) such as external hard drives or cloud-based storage. The operating system 1394 can control the allocation and usage of the components illustrated in FIG. 13 and support the application programs 1396.

The application programs 1396 can include common computing system applications (e.g., email applications, calendars, contact managers, web browsers, messaging applications) as well as other computing applications.

The computing system 1300 can support various additional input devices, such as a touchscreen, microphone, camera, touchpad, or trackpad, and one or more output devices, such as one or more speakers or displays. Any of the input or output devices can be internal to, external to, or removably attachable with the computing system 1300. External input and output devices can communicate with the computing system 1300 via wired or wireless connections.

The computing system 1300 can further include at least one input/output port comprising physical connectors (e.g., USB, FireWire, Ethernet, RS-232), a power supply (e.g., battery), a global satellite navigation system (GNSS) receiver (e.g., GPS receiver); a gyroscope; an accelerometer; and/or a compass. The computing system 1300 can further comprise one or more additional antennas coupled to one or more additional receivers, transmitters, and/or transceivers to enable additional functions.

It is to be understood that FIG. 13 illustrates only one example computing system architecture. Computing systems based on alternative architectures can be used to implement technologies described herein. For example, instead of the first processor unit 1302, the second processor unit 1304, and the graphics engine 1352 being located on discrete integrated circuit dies, a computing system can comprise an SoC (system-on-a-chip) integrated circuit die on which multiple processors, a graphics engine, and additional components are incorporated. Further, a computing system can connect its constituent component via bus or point-to-point configurations different from that shown in FIG. 13. Moreover, the illustrated components in FIG. 13 are not required or all-inclusive, as shown components can be removed and other components added in alternative embodiments.

FIG. 14 is a block diagram of an example processor unit to execute computer-executable instructions as part of implementing technologies described herein. The processor unit 1400 can be a single-threaded core or a multithreaded core in that it may include more than one hardware thread context (or “logical processor”) per processor unit.

FIG. 14 also illustrates a memory 1410 coupled to the processor unit 1400. The memory 1410 can be any memory described herein, or any other memory known to those of skill in the art.

The memory 1410 can store computer-executable instructions 1415 (code) executable by the processor unit 1400.

The processor unit comprises front-end logic 1420 that receives instructions from the memory 1410. An instruction can be processed by one or more decoders 1430. The one or more decoders 1430 can generate as its output a micro-operation such as a fixed width micro-operation in a predefined format, or generate other instructions, microinstructions, or control signals, which reflect the original code instruction. The front-end logic 1420 further comprises register renaming logic 1435 and scheduling logic 1440, which generally allocate resources and queues operations corresponding to converting an instruction for execution.

The processor unit 1400 further comprises execution logic 1450, which comprises one or more execution units (EUs) (execution unit 1465-1 through execution unit 1465-N). Some processor unit embodiments can include a number of execution units dedicated to specific functions or sets of functions. Other embodiments can include only one execution unit or one execution unit that can perform a particular function. The execution logic 1450 performs the operations specified by code instructions. After completion of execution of the operations specified by the code instructions, back-end logic 1470 retires instructions using retirement logic 1475. In some embodiments, the processor unit 1400 allows out of order execution but requires in-order retirement of instructions. Retirement logic 1475 can take a variety of forms as known to those of skill in the art (e.g., re-order buffers or the like).

The processor unit 1400 is transformed during execution of instructions, at least in terms of the output generated by the one or more decoders 1430, hardware registers and tables utilized by the register renaming logic 1435, and any registers (not shown) modified by the execution logic 1450.

Any of the disclosed methods (or a portion thereof) can be implemented as computer-executable instructions or a computer program product. Such instructions can cause a computing system or one or more processor units capable of executing computer-executable instructions to perform any of the disclosed methods. As used herein, the term “computer” refers to any computing system, device, or machine described or mentioned herein as well as any other computing system, device, or machine capable of executing instructions. Thus, the term “computer-executable instruction” refers to instructions that can be executed by any computing system, device, or machine described or mentioned herein as well as any other computing system, device, or machine capable of executing instructions.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some embodiments, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

As used in this application and the claims, the phrase “individual of” or “respective of” following by a list of items recited or stated as having a trait, feature, etc. means that all of the items in the list possess the stated or recited trait, feature, etc. For example, the phrase “individual of A, B, or C, comprise a sidewall” or “respective of A, B, or C, comprise a sidewall” means that A comprises a sidewall, B comprises sidewall, and C comprises a sidewall.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

The following examples pertain to additional embodiments of technologies disclosed herein.

Example 1 is a nut comprising: a body comprising an outer surface, a bottom surface, a top surface, and an opening, wherein the opening extends from the bottom surface to the top surface, a threaded first portion of the opening extends from the bottom surface towards the top surface, a second portion of the opening extends from the top surface and comprises a drive recess, and the body comprises a polymer; and a casing fitted to the outer surface of the body, wherein the casing extends at least a portion of a height of the body and the casing comprises a metal.

Example 2 comprises the nut of example 1, wherein the casing extends from the bottom surface to the top surface.

Example 3 comprises the nut of example 1 or 2, wherein the casing further covers at least a portion of the bottom surface of the body and the casing comprising an opening that is substantially aligned with the opening of the body.

Example 4 comprises the nut of example 1 or 2, wherein the casing further covers the top surface of the body, the casing comprising a drive opening that has a shape that substantially matches a shape of the drive recess of the body.

Example 5 comprises the nut of example 1 or 2, wherein the body further comprises a pedestal, the pedestal comprises a top surface, and the casing extends from the top surface of the pedestal towards the top surface of the body.

Example 6 comprises the nut of any one of examples 1-5, wherein an interior surface of the casing comprises a plurality of splines.

Example 7 comprises the nut of any one of examples 1-5, wherein an interior surface of the casing comprises a first plurality of tabs that engage with counterpart tabs located on the outer surface of the body.

Example 8 is a nut comprising: a body comprising an outer surface, a bottom surface, a top surface, and an opening, wherein the opening extends from the bottom surface to the top surface, a threaded first portion of the opening extends from the bottom surface towards the top surface, a second portion of the opening extends from the top surface and comprises a drive recess, and the body comprises a plastic; and a reinforcement structure embedded in the body, the reinforcement structure comprising a metal.

Example 9 comprises the nut of example 8, wherein the reinforcement structure is a sleeve that extends at least a portion of a height of the body.

Example 10 comprises the nut of example 9, wherein the sleeve is porous.

Example 11 comprises the nut of example 9, wherein the sleeve is solid.

Example 12 comprises the nut of example 9, wherein the sleeve is cylindrical shaped.

Example 13 comprises the nut of example 9, wherein the sleeve is a mesh.

Example 14 comprises the nut of example 9, wherein the sleeve comprises a plurality of holes.

Example 15 comprises the nut of example 8, wherein the reinforcement structure extends from the bottom surface to the top surface.

Example 16 comprises the nut of any one of examples 1-15, wherein the nut has a cylindrical shape.

Example 17 comprises the nut of any one of examples 1-16, wherein the metal is stainless steel or aluminum.

Example 18 is a nut comprising: a body comprising an outer surface, a bottom surface, a top surface, and an opening, wherein the opening extends from the bottom surface to the top surface, a threaded first portion of the opening extends from the bottom surface towards the top surface is threaded, a second portion of the opening extends from the top surface comprises a drive recess, and the body comprises a polymer; and a reinforcement means to increase a strength of the body.

Example 19 is a load assembly comprising: a heat sink; and a plurality of any one of the nuts of examples 1-18.

Example 20 is an assembly comprising: a socket comprising a plurality of threaded fasteners; an integrated circuit component inserted into the socket; and the load assembly of example 19, wherein the load assembly is attached to the socket via engagement of the plurality of any one of the nuts of claims 1-18 with the plurality of threaded fasteners of the socket.

Example 21 is a method comprising: placing a load assembly on a socket, wherein the socket comprises a plurality of fasteners and the load assembly comprises a plurality of nuts; and securing the load assembly to the socket by fastening the plurality of nuts to the plurality of fasteners of the socket.

Example 22 comprises the method of example 21, wherein the load assembly comprises a heat sink.

Example 23 is a method comprising: molding a nut body out of a polymer, wherein the nut body comprises an outer surface, a bottom surface, a top surface, and an opening, wherein the opening extends from the bottom surface to the top surface, a threaded first portion of the opening extends from the bottom surface towards the top surface, a second portion of the opening extends from the top surface comprises a drive recess, and the nut body comprises a polymer; and press-fitting a casing over the nut body, the casing comprising a metal.

Example 24 comprises the method of example 23, wherein press-fitting the casing over the nut body comprises heating the casing and press-fitting the casing over the nut body while the casing is still heated.

Example 25 comprises the method of example 23 or 24, wherein the casing extends from the bottom surface to the top surface.

Example 26 comprises the method of example 23 or 24, wherein the casing further covers at least a portion of the bottom surface of the nut body and the casing comprising an opening that is substantially aligned with the opening of the nut body.

Example 27 comprises the method of example 23 or 24, wherein the casing further covers the top surface of the nut body, the casing comprising an opening that has a shape that substantially matches a shape of the drive recess of the nut body.

Example 28 comprises the method of example 23 or 24, wherein the nut body further comprises a pedestal, the pedestal comprises a top surface, and the casing extends from the top surface of the pedestal towards the top surface of the nut body.

Example 29 comprises the method of any one of examples 23-24, wherein an interior surface of the casing comprises a plurality of splines.

Example 30 comprises the method of any one of examples 23-24, wherein an interior surface of the casing comprises a first plurality of tabs that engage with counterpart tabs located on the outer surface of the nut body.

Example 31 is a method comprising: molding a nut body out of a polymer, wherein the nut body comprises an outer surface, a bottom surface, a top surface, and an opening, wherein the opening extends from the bottom surface to the top surface, a threaded first portion of the opening extending from the bottom surface towards the top surface, a second portion of the opening extends from the top surface comprises a drive recess, and the nut body comprises a plastic; and molding a sleeve onto the nut body, the sleeve comprising a metal.

Example 32 comprises the method of example 31, wherein the nut body is an inner nut body, the method further comprising molding an outer nut body over the sleeve.

Example 33 comprises the method of example 31 or 32, wherein the sleeve extends at least a portion of a height of the nut body.

Example 34 comprises the method of example 31 or 32, wherein the sleeve is porous.

Example 35 comprises the method of example 31 or 32, wherein the sleeve is solid.

Example 36 comprises the method of example 31 or 32, wherein the sleeve is cylindrical shaped.

Example 37 comprises the method of example 31 or 32, wherein the sleeve is a mesh.

Example 38 comprises the method of example 31 or 32, wherein the sleeve comprises a plurality of holes.

Example 39 comprises the method of example 33, wherein the sleeve extends from the bottom surface to the top surface.

1. A nut comprising:
a body comprising an outer surface, a bottom surface, a top surface, and an opening, wherein the opening extends from the bottom surface to the top surface, a threaded first portion of the opening extends from the bottom surface towards the top surface, a second portion of the opening extends from the top surface and comprises a drive recess, and the body comprises a polymer; and
a casing fitted to the outer surface of the body, wherein the casing extends at least a portion of a height of the body and the casing comprises a metal.

2. The nut of claim 1, wherein the casing extends from the bottom surface to the top surface.

3. The nut of claim 1, wherein the casing further covers at least a portion of the bottom surface of the body and the casing comprising an opening that is substantially aligned with the opening of the body.

4. The nut of claim 1, wherein the casing further covers the top surface of the body, the casing comprising a drive opening that has a shape that substantially matches a shape of the drive recess of the body.

5. The nut of claim 1, wherein the body further comprises a pedestal, the pedestal comprises a top surface, and the casing extends from the top surface of the pedestal towards the top surface of the body.

6. The nut of claim 1, wherein an interior surface of the casing comprises a plurality of splines.

7. The nut of claim 1, wherein an interior surface of the casing comprises a first plurality of tabs that engage with counterpart tabs located on the outer surface of the body.

8. A nut comprising:
a body comprising an outer surface, a bottom surface, a top surface, and an opening, wherein the opening extends from the bottom surface to the top surface, a threaded first portion of the opening extends from the bottom surface towards the top surface, a second portion of the opening extends from the top surface and comprises a drive recess, and the body comprises a plastic; and
a reinforcement structure embedded in the body, the reinforcement structure comprising a metal.

9. The nut of claim 8, wherein the reinforcement structure is a sleeve that extends at least a portion of a height of the body.

10. The nut of claim 9, wherein the sleeve is porous.

11. The nut of claim 9, wherein the sleeve is solid.

12. The nut of claim 9, wherein the sleeve is cylindrical shaped.

13. The nut of claim 9, wherein the sleeve is a mesh.

14. The nut of claim 9, wherein the sleeve comprises a plurality of holes.

15. The nut of claim 8, wherein the reinforcement structure extends from the bottom surface to the top surface.

16. An assembly comprising:
a socket comprising a plurality of threaded fasteners;
an integrated circuit component inserted into the socket; and
a load assembly comprising a heat sink and a plurality of nuts, wherein individual of the plurality of nuts comprise:
a body comprising an outer surface, a bottom surface, a top surface, and an opening, wherein the opening extends from the bottom surface to the top surface, a threaded first portion of the opening extends from the bottom surface towards the top surface, a second portion of the opening extends from the top surface and comprises a drive recess, and the body comprises a polymer; and
a casing fitted to the outer surface of the body, wherein the casing extends at least a portion of a height of the body and the casing comprises a metal;
wherein the load assembly is attached to the socket via engagement of the plurality of nuts with the plurality of threaded fasteners of the socket.

17. The assembly of claim 16, wherein the casing extends from the bottom surface to the top surface.

18. The assembly of claim 16, wherein the casing further covers at least a portion of the bottom surface of the body and the casing comprising an opening that is substantially aligned with the opening of the body.

19. The assembly of claim 16, wherein the casing further covers the top surface of the body, the casing comprising a drive opening that has a shape that substantially matches a shape of the drive recess of the body.

20. The assembly of claim 16, wherein an interior surface of the casing comprises a plurality of splines or tabs.
